(19) United States
(12) Patent Application Publication
(10) Pub. No.: US 2004/0211587 A1
(43) Pub. Date: Oct. 28, 2004

(54) Suspension insulator with a sealing plug

(75) Inventor: Daniel De Decker, Cusset (FR)

Correspondence Address: Ware, Fressola, Van Der Sluys & Adolphson LLP, Bradford Green, Building Five, 755 Main Street, PO Box 224, Monroe, CT, 06468, US

(73) Assignee: SEDIVER, SOCIETE EUROPEENNE D'ISOLAETURS EN VERRE ET COMPOSITE

(21) Appl. No.: 10/830,518

(22) Filed: Apr. 23, 2004

(30) Foreign Application Priority Data
Apr. 23, 2003 (FR) 0304980

(51) Int. Cl. H02G 15/00

(52) U.S. Cl. 174/138 G

(57) ABSTRACT

The suspension insulator comprises an insulating skirt of quenched glass or of porcelain having an underside in which a pin is fixed by a cement-based binder, a sacrificial ring made of zinc in contact with the binder and surrounding the pin, and an annular plug of electrically conductive material disposed between the insulating skirt and the sacrificial ring in such a manner as to provide sealing that prevents leakage currents from passing through the binder. The plug serves to avoid corrosion phenomena of the pin and the risk of the insulator exploding.

The invention relates to suspension insulators, and more particularly to so-called cap and pin insulators comprising an insulating skirt made of dielectric material such as quenched glass or porcelain having an underside in which a pin is secured by means of a cement-based binder, and a sacrificial ring made of a metal, in particular zinc, in contact with the binder and surrounding the pin.

### BACKGROUND OF THE INVENTION

Such suspension insulators are designed to be assembled to one another so as to make insulator strings that are used as supports for high and medium voltage electricity lines. They can be subjected to climatic conditions that are very severe, such as an environment that is particularly moist in the tropics.

Because of the way it is made, such a cap and pin insulator presents clearance between the inside of the skirt, the binder, and the pin. In a moist environment, water can penetrate into the interstices that form between the insulating skirt, the binder, and the pin, thereby facilitating the passage of leakage currents along said interstices.

Such leakage currents lead to the pin being attacked by chemical corrosion and electrochemical corrosion. Corrosion of the pin has the effect of weakening the pin mechanically, and in addition has the effect of forming iron oxide around the pin, thereby leading to expansion stresses on the skirt that can lead to the insulator exploding.

In a suspension insulator known from patent GB 1 025 554, corrosion of the pin 3 is avoided in part by placing a ring of zinc 5 around the pin to act as a sacrificial electrode in contact with the binder 4, as shown in FIG. 1, where corrosion has taken place on the surface of the zinc electrode. In such a structure, the sacrificial zinc ring 5 prevents the pin 3 corroding at the specific location where it is placed, however it has a short lifetime and is ineffective in the zone of the pin that is not protected by the ring.

An alternative for remedying that drawback is proposed in Japanese patent application filed under the No. JP2002216559, as shown in FIG. 2, which consists in replacing the zinc ring 5 disposed at the periphery of the pin 3 in contact with the binder 4, by a zinc conductive ring 6. The conductive ring 6 is disposed around the pin being embedded in part in the binder 4 and being almost in contact with the pin 3 and the insulating skirt 1. In such an insulator, leakage current is channeled via the conductive ring 6, thereby limiting leakage currents between the binder 4 and the pin 3 and thus minimizing the risks of corroding the pin, with the zinc conductive ring then acting as a sacrificial electrode. In such a device, although the lifetime of the pin is lengthened by diverting leakage currents, the poor sealing inherent to the method of manufacture implies that small leakage currents will subsist between the binder 4 and the pin 3, which means that the insulator will continue to be degraded.

Another alternative for remedying this drawback is proposed in U.S. Pat. No. 4,559,414, in which a sacrificial ring surrounds the pin at the edge of the binder, and an electrically insulating film made of synthetic resin is stuck against the surface of the pin that is embedded in the binder and over a portion of the sacrificial ring so that the sacrificial ring is subjected to all of the corrosion and protects the pin. In such a device, the sacrificial ring has a short lifetime and the leakage current always passes through the binder.

### OBJECT AND SUMMARY OF THE INVENTION

The object of the invention is to remedy those drawbacks in order to further lengthen the lifetime of suspension insulator components.

To this end, the invention provides a suspension insulator comprising an insulating skirt of quenched glass or of porcelain, with an underside in which a pin is fixed by a cement-based binder, and a sacrificial ring of zinc in contact with the binder and surrounding the pin, wherein an annular plug of electrically conductive material is disposed between the insulating skirt and the sacrificial ring, in such a manner as to provide sealing that prevents leakage currents from flowing through the binder.

Consequently, in the insulator of the invention, the conductive plug prevents any penetration of moisture into the underside of the skirt, thereby preserving the components of the insulator from any degradation, particularly in moist conditions.

In a particular embodiment of the insulator of the invention, the conductive plug and the ring present an annular contact area of height lying in the range 5 millimeters (mm) to 10 mm. This contributes to obtaining a reactive surface area on the sacrificial ring that is quite extensive, thereby increasing its lifetime.

In another particular embodiment of the insulator of the invention, the binder partially overlies the sacrificial ring, so that the leakage currents at the surface of the binder attack the ring.

In yet another particular embodiment of the insulator of the invention, the material used for the conductive plug is a flexible material, so that it adapts to the dimensional variations of the various elements of the insulator, thus ensuring good sealing for the device. By way of example, the conductive material is an elastomer filled with electrically conductive particles suitable for being deposited by being injected, in particular an elastomer filled with carbon particles.

### BRIEF DESCRIPTION OF THE DRAWINGS

The invention, its characteristics, and its advantages are described in greater detail in the following description in association with the figures listed below.

FIG. 1 is a partial axial section of a prior art suspension insulator having a sacrificial ring of zinc placed around the pin.

FIG. 2 is a partial axial section of a prior art suspension insulator having a conductive ring partially embedded in the binder and surrounding the pin.

FIG. 3 is a partial axial section of a suspension insulator of the invention.

FIG. 4 shows a method of manufacturing an insulator of the invention.

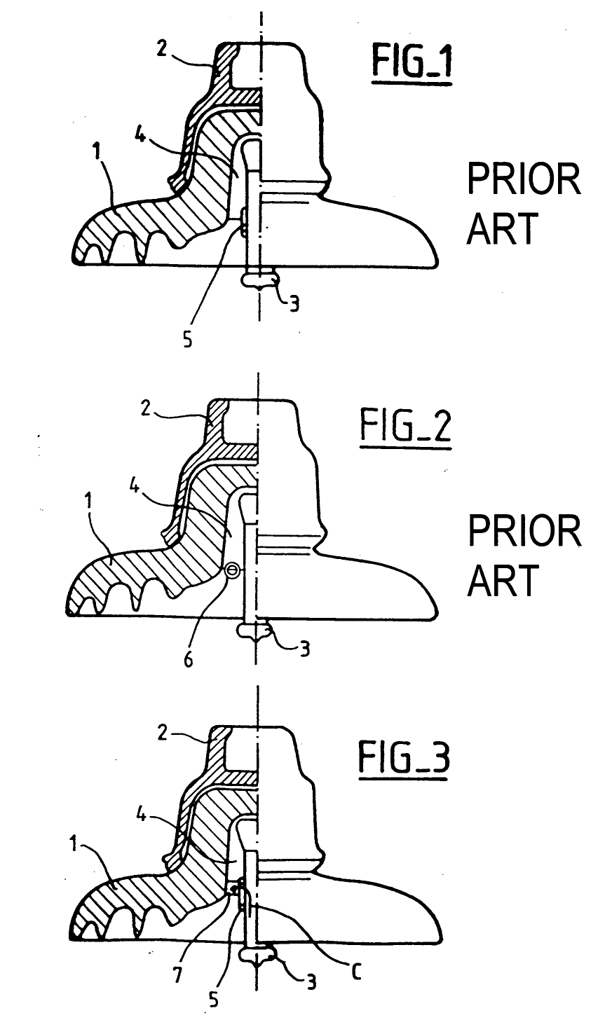

### MORE DETAILED DESCRIPTION

FIG. 3 shows a suspension insulator of the invention in partial section comprising an electrically insulating skirt 1 of quenched glass or of porcelain, with a head covered by a metal cap 2 and an underside forming a bushing in which a metal pin 3 is embedded.

The metal pin 3 of an insulator and the metal cap 2 of another insulator are connected to each other in order to build up a chain of insulators.

The pin 3, e.g. made of steel, is embedded in the underside of the insulating skirt 1 by a binder 4 that is based on cement. A ring 5, preferably made of zinc, is placed around the pin 3 and is in contact with the binder 4. Zinc is used because its anode properties are better than those of the steel of the pin 3. Corrosion due to the presence of leakage currents thus acts initially on the ring 5. However, leakage currents can still pass between the binder 4 and the pin 3, leading to corrosion of the pin and to the formation of iron oxide in the interstice. This results in abnormal radial expansion of the insulator which can lead to the head of the insulating skirt exploding. The conductive ring 6 used for deflecting these leakage currents, as shown in FIG. 2, is effective in limiting the risks of the pin 3 corroding and thus the risk of the insulator exploding, however water is not prevented from infiltrating into the interstices between the binder 4 and the insulating skirt 1 or between the binder 4 and the pin 3. Small leakage currents can thus lead to elements of the insulator being degraded.

In the invention, an electrically conducive annular plug 7 is placed, as shown in FIG. 3, between the zinc ring 5 and the skirt 1, coming into contact with the binder 4.

The conducive characteristic of the plug serves to deflect leakage currents which are represented in FIG. 3 by an arrow C so that they flow along the underside of the insulating skirt as occurs when a conductive ring is used.

In addition, the plug 7 seals the exposed binder 4 between the skirt 1 and the sacrificial ring 5 so as to prevent any penetration of moisture into the interstices between the binder 4 and the insulating skirt 1 or between the binder 4 and the pin 3. This sealing contributes to concentrating chemical corrosion and electrochemical corrosion phenomena on the sacrificial ring 5.

The increase in the lifetime of the zinc sacrificial ring 5 is obtained by increasing the area of contact between the conductive plug 7 and the sacrificial ring 5. The height of this annular contact area lies in the range 5 mm to 10 mm.

As can be seen in FIG. 3, the bottom portion of the binder 4 overlaps part of the sacrificial ring 5 so that the leakage current at the surface of the binder attacks the ring.

The material used for the conductive annular plug 7 is preferably a flexible material which adapts to the dimensional variations of the various elements of the insulator. The flexible material is preferably an elastomer filled with electrically conductive particles, in particular particles of carbon. The cross-section of the annular plug 7 may be constant or otherwise, and it may be rectangular in shape, or otherwise.

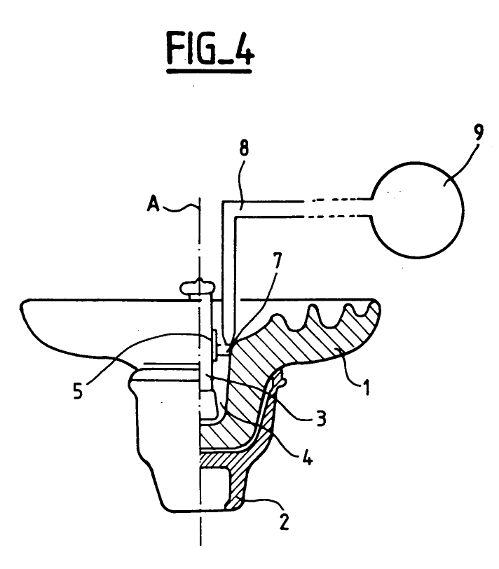

After the pin 3 with the ring 5 previously cast thereon has been assembled with the skirt 1 by applying the binder 4, the elastomer is injected around the pin over the binder. Injection can be performed at ambient temperature, as shown in FIG. 4, using a nozzle 8 delivering a semiliquid elastomer contained in a positive displacement pump 9, the elastomer being deposited onto the binder while the insulator is rotating about the axis A of the pin 3 in a head-down position. The positive displacement pump is fed by pistons that serve to mix the components of the elastomer.

The insulator sealing plug of the invention is simple and inexpensive to apply and enables the lifetime of the insulator to be prolonged so as to be substantially equal to the lifetime of the sealing plug.

1. A suspension insulator comprising an insulating skirt of dielectric material having an underside in which a pin is fixed by a cement-based binder, and a sacrificial metal ring in contact with the binder and surrounding the pin, wherein an annular plug of electrically conductive material is disposed between the insulating skirt and the sacrificial ring in such a manner as to provide sealing that prevents leakage currents flowing through the binder.

2. An insulator according to claim 1, in which the conductive plug and the sacrificial ring present an annular contact area of height lying in the range 5 mm to 10 mm.

3. An insulator according to claim 1, in which the binder overlaps part of the sacrificial ring.

4. An insulator according to claim 1, in which the material used for the conductive plug is a flexible material.

5. An insulator according to claim 4, in which the conductive material is an elastomer filled with electrically conductive particles.

6. An insulator according to claim 4, in which the electrically conductive particles are particles of carbon.

7. A chain of suspension insulators comprising a plurality of suspension insulators according to claim 1.

8. A method of manufacturing a suspension insulator according to claim 1, the method consisting in forming the annular plug by injecting an elastomer material around the pin and onto the binder while the insulator is rotating about its axis.
